(19) United States
(12) Patent Application Publication
(10) Pub. No.: US 2012/0241553 A1
(43) Pub. Date: Sep. 27, 2012

(54) HELICOPTER WITH TWO OR MORE ROTOR HEADS

(76) Inventor: Paul Wilke, The Hague (NL)

(21) Appl. No.: 13/187,451

(22) Filed: Oct. 13, 2011

Related U.S. Application Data
(60) Provisional application No. 61/365,779, filed on Jul. 20, 2010.

(51) Int. Cl. B64C 27/08; B64C 27/57

(52) U.S. Cl. 244/17.13; 244/17.23

(57) ABSTRACT

A helicopter with two or more rotor heads with full swash plate control and a novel control scheme to allow for propulsion in the horizontal plane in all directions, allowing the aircraft to fly in all directions in a truly horizontal fashion. Furthermore, a manual input device to control the additional control freedoms thus gained, and an electronic control system that combines manual inputs with inputs from sensors and translates these inputs into directions for the actuators of the two or more swash plates in order to control the aircraft, taking into account the novel control scheme.

### CROSS REFERENCE TO RELATED APPLICATIONS

This application claims the benefit of Provisional U.S. Patent Application No. 61/365,779, filed Jul. 20, 2010, the entirety of which is incorporated herein by reference.

### BACKGROUND OF THE INVENTION

The vast majority of helicopters presently in use is of the single rotor type, which type, as was already noted by Beckwith in U.S. Pat. No. 3,002,712, suffers from the requirement of one-hundred percent reliability of each of the parts in order to be considered safe enough for manned flight. The only exception to this rule is that with some kinds of incidents such as engine failure, a helicopter may be saved by storing energy in the rotor blades during descend, to be released shortly before landing to slow down the aircraft. This is called autorotation, and in order to work effectively, it requires the rotor blades to be sufficiently heavy to accumulate the required amount of energy. The use of two or three rotors does not improve matters, since in case of failure of one, the craft can still not be stabilized. As a result, many different technical solutions have been pondered in the direction of multi (two or more)-rotor type helicopters, which offer enhanced safety by offering redundancy that allows one or more rotors to fail without catastrophic results. See for example U.S. Pat. No. 7,699,260 (Hughey). Multiple rotors may have weight advantages too, as is stated in U.S. Pat. No. 2,651,480 (Pullin) on account of the cube/square law, according to which the total weight of the rotors and their transmissions tends to be inversely proportional to the square root of the number of rotors (of substantially identical dimensions and characteristics) between which a given load is distributed.

Multi-rotor helicopters in the existing art all rely on thrust differentials between the different rotor heads in order to position the craft in the horizontal plane. This can be either achieved by changing the pitch of the propellers as in U.S. Pat. No. 2,540,404 (Neale) and U.S. Pat. No. 2,651,480 (Pullin), or by changing the speed of revolution of the rotors, such as in US Patent Publication 200500619190 (Wobben), U.S. Pat. No. 7,699,260 (Hughey) and German Patent DE 10 2005 022 706 A1. The latter solution limits the size of the rotor to be used, because in larger rotor sizes, the momentum is such that rapid control movements cannot be adequately translated into the desired rotational speed. Therefore, for sizeable multi-rotor aircrafts, either pitch control is required to generate sufficiently controllable thrust differentials between the rotor heads, or a large number of smaller rotors.

For the propulsion of multi-rotor helicopters, three basic set-ups are employed in the present art. The first consists of deriving propulsion from the down force generated by the rotors by tilting the orientation of the flying machine with respect to the horizon. In this regard, they are maneuvered through the air in exactly the same way single rotor helicopters are. Examples are U.S. Pat. No. 3,082,977 (Arlin) and the Convertawings Model A, which first flew in 1956. One disadvantage of this set-up is that in forward flight, the aircraft is tilted against the direction of motion, generating drag. It also limits the use as a stabilized platform, e.g. to mount a camera on. The main reason is that for positioning itself in the horizontal plane, such helicopters can only be steered indirectly to the desired position. That is, first the aircraft has to be tilted into the direction of the desired position, and once it is there, it has to be tilted into the opposite direction in order to brake, before going into level flight again. Hence the analogy that is often used, which is that flying such helicopters is like balancing while standing on top of a large ball.

A second setup that is employed for generating propulsion is by tilting one or more of the rotors individually, such as in U.S. Pat. No. 3,284,027 (Mesniere), U.S. Pat. No. 3,592,412 (Glatfelter) and U.S. Pat. No. 6,254,032 (Bucher), or by deflecting the airflow through vanes, such as in U.S. Pat. No. 5,155,996 (Moller). The main disadvantages of these solution are mechanical complexity, stability issues when rotors are tilted, and drag in forward motion.

The third solution for generating propulsion in the existing art consists of adding separate propellers for propulsion such as in US Patent Application Publication US 2005/0061910 (Wobben) or by a jet engine as in U.S. Pat. No. 3,889,902 (Madet). Disadvantages are either aerodynamically as in the case of Wobben, or limitations in maneuverability as in the case of Madet, since the force in the horizontal plane can only be exercised in one direction.

The present invention introduces a novel means of propelling helicopters with two or more rotors, thus opening the way for helicopters that are safer to operate, more controllable and more efficient than those existing in the present art. Because of this novel means of propulsion, the improved helicopter can be maneuvered in the horizontal plane while remaining fully horizontal itself The novel means of propelling helicopters can be used with a minimum number of two rotors, but in order to gain the full safety benefits, a number of four or more in a symetrical configuration is preferred.

### SUMMARY

The invention relates to an improved helicopter that provides better efficiency, enhanced maneuverability and more safety as compared to the existing art. This purpose is achieved by introducing a novel way of generating forces in the horizontal plane in order to propel the aircraft in any desired direction. This works by mounting a preferably even number of rotor heads, with full swash plate control, in a rectangular or otherwise symmetrical configuration. In the case of two rotor heads, the configuration is limited to concentric mounting of the rotors. By individually controlling the swash plate of each rotor head according to a novel control scheme, forces may be generated that lie strictly in the horizontal plane, thus gaining an additional degree of control freedom. This novel means of propulsion enables this improved helicopter to move both forward/backward and side to side while oriented in a fully horizontal position. This novel feat contributes to the enhanced efficiency and to the usability as a stabilized platform, while the general set-up leads to increased safety. It may also render an aerial platform for hoisting operations that would be much more reliable to fix at a desired position, so that for example sky cranes and rescue helicopters are easier to control and may be deployed in situations which lie outside of the present flight envelope.

In order to describe the novel degrees of control freedom to move in the horizontal plane, left/right movement in the horizontal plane will henceforth be called Horizontal X (Hx), and forward/backward movement in the horizontal plane will be called Horizontal Z (Hz). In manual control, the increased degrees of control freedom will allow operators to be much more precise in positioning the aircraft than with existing helicopters. The reason is that there is for the first time a direct control in the horizontal plane, whereas with conventional helicopters this is only indirect (through tilting the aircraft and flying it to the desired position, then tilting it back to the original position). An ergonomically justified improvement is disclosed to the joystick presently utilized to control aileron and elevator, thus allowing this new control freedom to be assimilated easily within the present manual control system for helicopters. The introduction of this new control freedom also allows for additional sensors—e.g., accelerometers—to be used directly for stabilizing the aircraft, in addition to the gyroscope based stabilization setups presently in use.

This enhanced controllability leads to increased safety, which is further enhanced by an architecture whereby in a preferred embodiment two counter-rotating rotors are mounted in opposite corners, in which setup a minimum of four rotors is required. Thus, if one of the at least four rotors were to fail, stable flight may still be achieved on the three remaining rotors, with the novel control scheme allowing for full controllability in all axes.

There are a number of sources from which efficiency gains are derived. The first is that a number of smaller rotors mounted in relatively close proximity effectively combine aerodynamically to create the effect of, or behave as a single rotor of a much larger size, while weighing much less than a single rotor of such size would. Since the aircraft is inherently stable even with one rotor failing, there is no longer a need to have rotor blades heavy enough to save the aircraft in case of emergency by autorotation. These weight savings lead to an immediate gain in efficiency, both in hovering and in dynamic flight.

A second efficiency gain is achieved in dynamic flight. Since the aircraft can fly in a fully horizontal manner, the frontal area that generates drag is much smaller than in conventional helicopters, which have to tilt into the direction of flight in order to fly in a horizontal direction.

Further efficiency is gained since this invention does not require a tail rotor, as conventional helicopters do.

Another source of improved efficiency is that with conventional helicopters, the fuselage can only be mounted in the down wash of the rotor. The down force this creates has to be overcome by generating more lift. With the present invention, the fuselage can be mounted in between the rotors, thereby keeping it out of the down wash.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is an overview of multiple mounting arrangements of four rotor heads in terms of direction of rotation.

FIG. 2 provides an example with two concentric rotors.

FIG. 3 provides an example of an arrangement with six rotor heads.

FIG. 4 is a top view of part of a rotor assembly, identifying the main principles.

FIG. 5 is a top view of a rotor assembly, showing torque forces.

FIG. 6 is a top view of a rotor assembly, showing forces in the horizontal plane (H-forces).

FIG. 7 is a drawing of a manual input device that can cope with two new control freedoms.

FIG. 8 depicts the electronic control system.

FIG. 9 is a drawing of a helicopter with four rotors with full swash plate control.

### DETAILED DESCRIPTION OF A PREFERRED EMBODIMENT OF THE INVENTION

The present invention gains an additional degree of freedom by using aerodynamic drag differences in each rotor blade as they go through a 360 degrees rotation, and the combination of these forces generated by two or more rotor blades according to a novel scheme. In the embodiment here described, there are four rotor heads, but in an analogous way the same applies to embodiments with smaller or larger numbers of rotors, an example of which is given.

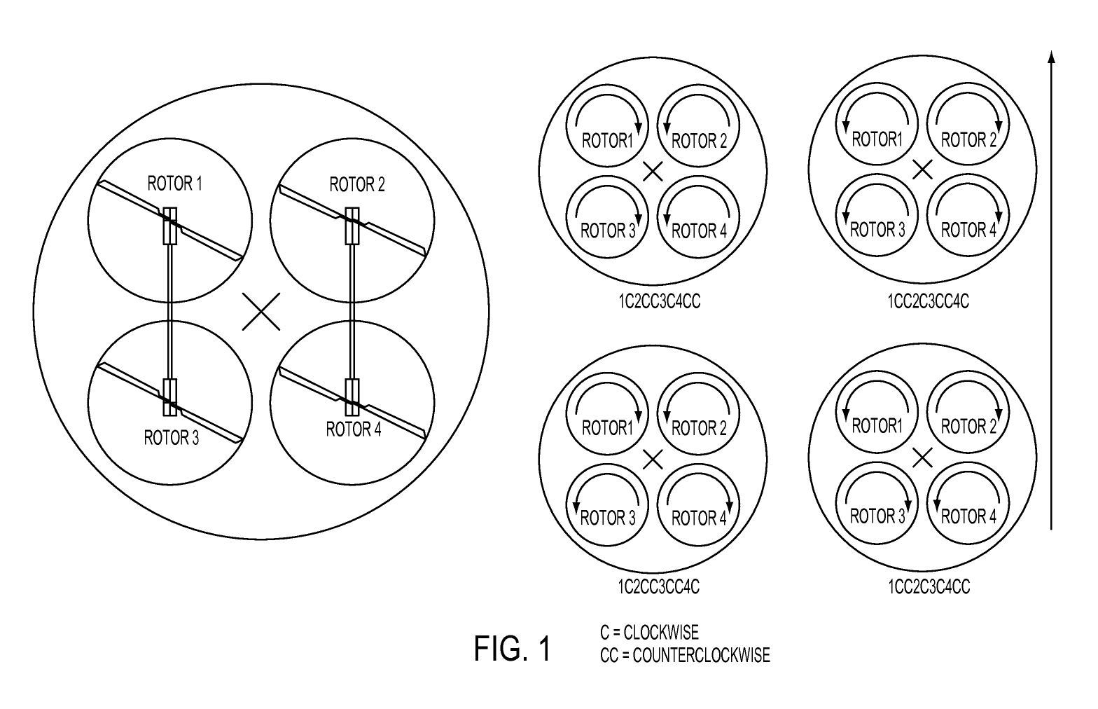

FIG. 1 explains the different possibilities that exist for the rotation of each of the rotors with respect to the main direction of movement in the case of four rotors. In order to name these different set-ups, the numerals 1 . . . 4 stand for the rotor head number, C for clockwise rotation and CC for counter-clockwise rotation. Thus, the designation 1C2CC3C4CC describes essentially similar rotor movement as does the designation 1CC2C3CC4C, the principal difference being the main direction of movement. The same relative relationship holds true for the other two set-ups, 1C2CC3CC4C and 1CC2C3C4CC. The latter two set-ups, however, are inherently unstable in case of failure of one of the rotor heads, as will be explained further on.

Before going into the scheme according to which this invention can be moved along in the horizontal plane, some concepts will have to be set out first, most of which are well known from the existing art.

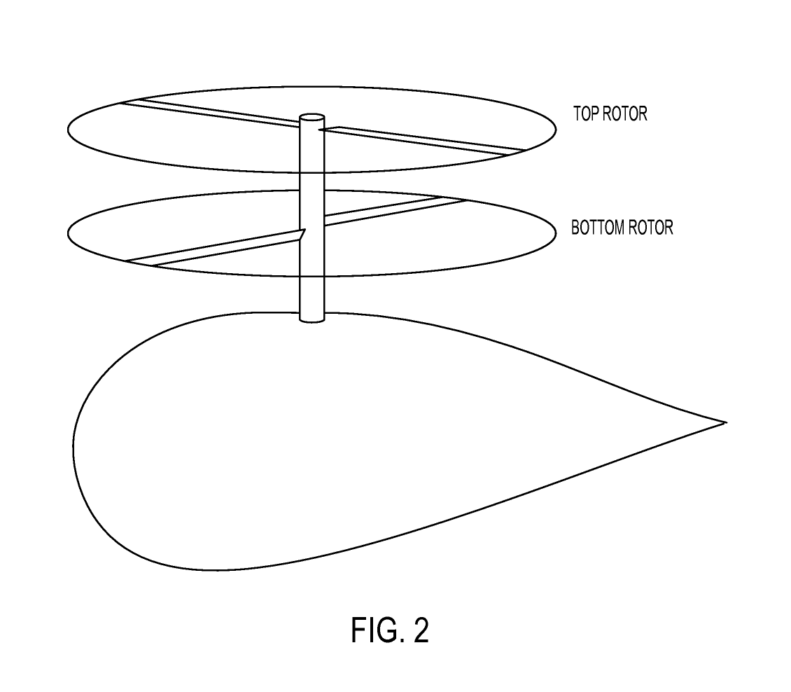

FIG. 2 shows a concentric set-up with two counter-rotating rotors. For the case of two concentric rotors, there will be a bottom rotor (B) and a top rotor (T), hence two different set-ups: BCCTC and BCTCC, which are functionally equivalent.

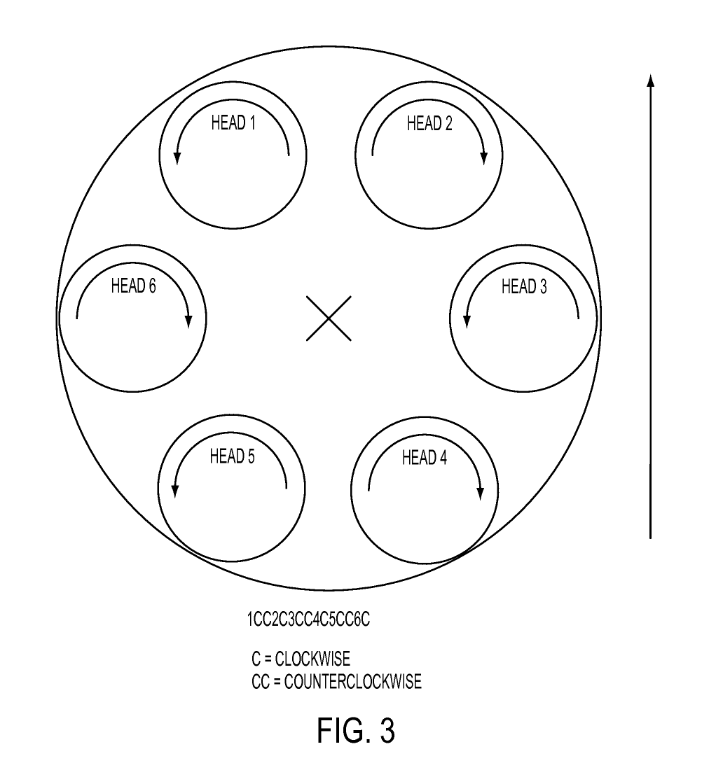

FIG. 3 depicts a set-up with six rotor heads, which would have as one advantage over a set-up with four rotor heads, that the increased redundancy would even further enhance safety in the case of failure of one or more rotor heads, at the cost of increased technical complexity.

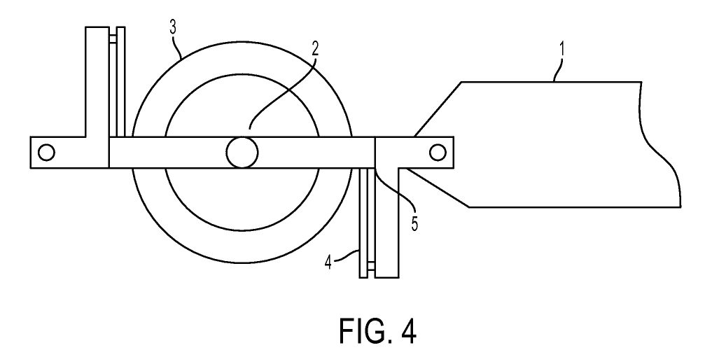

FIG. 4 depicts a helicopter rotor with blades and swash plate. The rotor blades 1 are attached to the main shaft 2 in a flexible way, so that the pitch of the blades may be varied. This is accomplished by a swash-plate 3 that is connected to a lever 4 on the hinge point 5 of the blades, so that the pitch of the blades follows the position of the swash plate. If the swash plate is in the same plane as the rotor blades, all blades will have the same pitch when they travel through a 360 degrees rotation. However, if the swash plate is tilted, the blades will vary their pitch when they travel through these 360 degrees. For the purposes of this embodiment of the invention, it is assumed that there is no phase difference between swash plate and rotor blade. In other words, when the swash plate is tilted, the rotor blade connected to it will reach its lowest pitch at the point where the swash plate is lowest. Similarly, a rotor blade will reach its highest pitch at the point where the swash plate is highest.

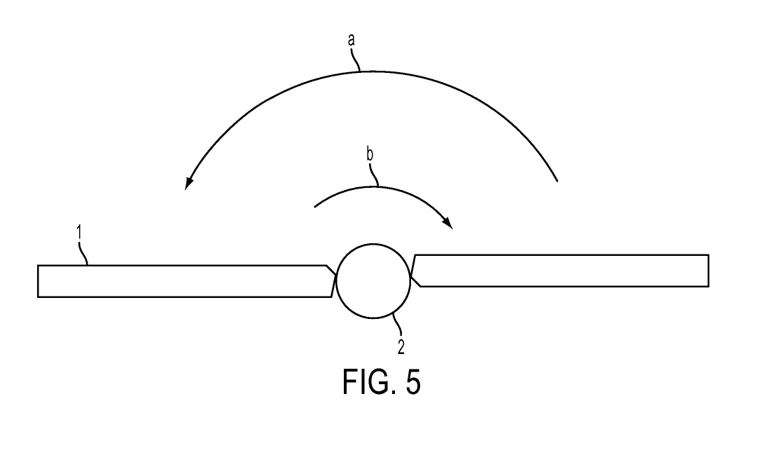

FIG. 5 depicts that rotor blades 1 that move through the air with constant pitch in a circular motion a instill a rotary reaction force on the main shaft 2 in the opposite direction b. In single rotor helicopters, this force is counteracted by a tail rotor. In a preferred embodiment of this invention, the rotary reaction forces generated by two or more rotors cancel each other out.

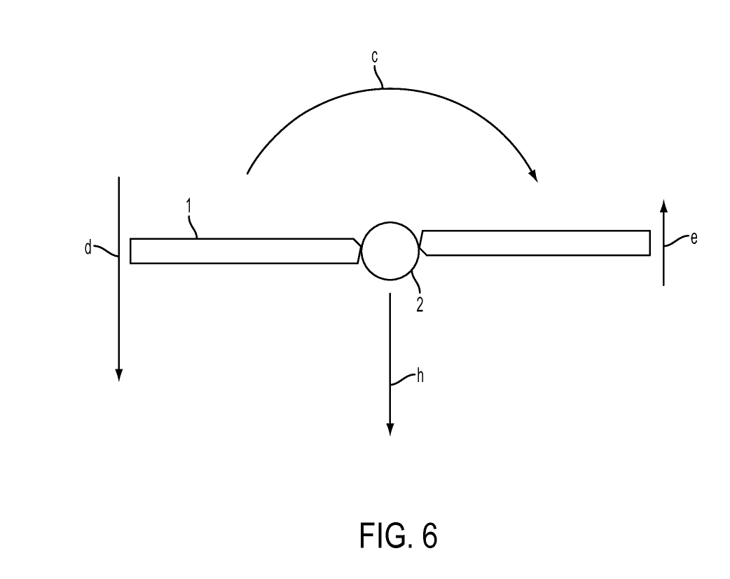

FIG. 6 depicts the forces involved in a situation where the swash plate is tilted. In this example a rotor blade 1 turns in a clockwise direction about shaft 2, as indicated by curved arrow c, and the swash plate (not shown) gives aileron to the right. In other words, the blade turning forward is pushed up to a higher pitch by the swash plate than the blade turning backward, generating more lift on the left side of the rotor disc, generating a force that attempts to tilt the rotor disc to the right. In the preferred embodiment of this invention, the rotors are mounted in a rigid frame so that they transfer this tilting force to the whole structure to which the rotors are attached. By implementing the novel control scheme mentioned below, all these tilting forces can be made to cancel each other out, leaving the resulting forces that are described in the following paragraph.

The novel force used to propel this aircraft is based on the following. In the example of FIG. 6, since each blade generates more lift as it is moving forward than when the blade is going backward, each blade as it is moving forward also generates more drag, as shown by arrow d, in the plane of rotation than when the blade is turning backwards, as is shown by arrow e. The end result is a force in the plane of the rotor disc perpendicular to the main shaft 2 of the rotor, acting to push the rotor backward, as depicted by arrow h. Henceforth, this force will be called the H-force.

By combining these H-forces from two or more rotor heads, propulsion can be created in all directions to move the aircraft in the horizontal plane, without tilting the plane of the rotors. The same H-forces can also be used to rotate the aircraft in any direction for rudder control. The following scheme 1 shows which control inputs will have to be given to the individual rotor heads in order to achieve this combination of propulsion and rudder control, based on a 1C2CC3C4CC setup:

Scheme 1 - Control inputs to individual rotor heads for controlling
an aircraft through management of H-forces

| Head | Input Hz | Input Hx | Input Rud |
|---|---|---|---|
| 1 | F: A.L. | R: E.D. | R: ½ A.L. + ½ E.D. |
| | B: A.R. | L: E.U. | L: ½ A.R. + ½ E.U. |
| 2 | F: A.R | R: E.U. | R: ½ A.L. + ½ E.U. |
| | B: A.L. | L: E.D. | R: ½ A.R. + ½ E.D. |
| 3 | F: A.L. | R: E.D. | R: ½ A.L. + ½ E.U. |
| | B: A.R. | L: E.U. | L: ½ A.R. + ½ E.D. |
| 4 | F: A.R. | R: E.U. | R: ½ A.L + ½ E.D. |
| | B: A.L. | L: E.D. | L: ½ A.R + ½ E.U. |

Legend:
Head numbers refer to the setup as depicted in FIG. 1.
Hz = Horizontal Z
Hx = Horizontal X
Rud = Rudder
F = Forward Helicopter
B = Backward Helicopter
R = Right Helicopter
L = Left Helicopter
A.R = Right Aileron
A.L. = Left Aileron
E.D. = Elevator Down
E.U. = Elevator Up

For other rotational configurations or larger or smaller numbers of rotors, analogous schemes can be established. The basic rule is that for Hz and Hx movements, all clock wise rotating rotors require similar control inputs as Heads 1 and 3 of this Scheme 1, and all counter clock wise rotating rotors share similar control inputs with Heads 2 and 4. For rudder, this is slightly more complicated, since for rotational control over the Y-axis, it is most efficient to create H-forces that are perpendicular to the imaginary line that connects a rotor head to the centre of gravity of the aircraft. This can be achieved by providing each rotor head with a proportion of aileron and elevator inputs simultaneously. However, different schemes may be envisaged for rudder control, amongst which the use of torque differentials as is being employed in the present art for helicopters with more than one rotor.

To facilitate understanding this Scheme 1 “Control inputs to individual rotor heads for controlling an aircraft through management of H-forces”, the following two examples are provided.

Using the principles herein disclosed, the following exemplary process may be used to create a net forward horizontal force: Sending an “Aileron Left” instruction to Heads 1 and 3, and simultaneously sending an “Aileron Right” instruction to Heads 2 and 4, will result in the desired net forward horizontal force. This combination of instructions can be generated by a control system that may include an operator or pilot, as well as sensors for flight stabilization. Similarly, a command generated by an operator, pilot or sensors for “Left Horizontal X” may be executed by sending an “Elevator Up” instruction to Heads 1 and 3, while a simultaneous “Elevator Down” instruction is sent to Heads 2 and 4.

Thus, as can be seen by these examples of the exemplary control Scheme 1, by combining the H-forces of 4 rotor blades in a coordinated fashion according to this scheme, full horizontal control can be achieved to move along the XZ plane without tilting the rotor discs.

In order to control this craft in roll and pitch, the thrust or pitch of each individual rotor head can be varied by operator, pilot of sensor inputs. This set-up is known from the existing art and is generally applied to helicopters more than one rotor. Since this principle is applied in the preferred embodiment, it enables this invention to be controlled in a similar fashion as conventional helicopters, but with the addition of the new control freedoms Hx and Hz. The inputs for roll and pitch are processed by the control system that combines these inputs with those for Hx, Hz and rudder, in order to bring the individual swash plates in the desired positions.

The embodiment of the invention employing the 1C2CC3C4CC and 1CC2C3CC4C set-ups as disclosed provides improved safety in an application such as conventional helicopter operation, by virtue of the fact that in case of failure of one rotor head, two opposing, counter rotating rotor heads remain operational, which are thus able to keep the craft airborne and stable in the rotation around the Y-axis, with the third remaining rotor head providing control over stability in the XZ-plane. For the same reason the embodiment of the invention employing the 1C2CC3CC4C and 1CC2C3C4CC set-ups is inherently less safe for use in an application such as conventional helicopter operation, although they might find use in special applications. With these set-ups, if one of the rotor heads fails, there will be only counter-rotating rotors left on one side of the craft, rendering simultaneous horizontal and rotational stabilization impossible. By employing more than four rotor heads, e.g. six or eight, additional redundancy may increase safety even further, at the cost of increased mechanical complexity.

In the case of two counter-rotating concentric rotors, rudder, aileron and elevator control cannot be applied in the same manner as set out above for four or more rotors, hence the following Scheme 2 in order to explain this further for a TCBCC configuration.

Scheme 2 - Control inputs to two concentric rotors for controlling
an aircraft through management of H-forces

| Rotor | Input Hz | Input Hx | Input Rud |
|---|---|---|---|
| T | Fh: AL.L. | Rh: EL.D. | R: CL− |
| | Bh: AL.R. | Lh: EL.U. | L: CL+ |
| B | Fh: AL.R | Rh: EL.U. | R: CL+ |
| | Bh: AL.L. | Lh: EL.D. | L: CL− |

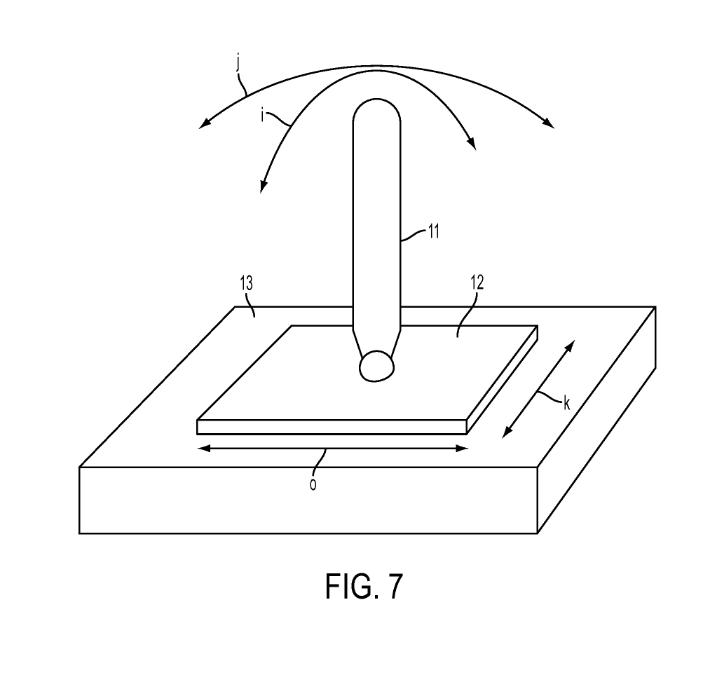

Legend:
Rotor numbers refer to the setup as depicted in FIG. 2.
Hz = Horizontal Z
Hx = Horizontal X
Rud = Rudder
Fh = Forward helicopter
Bh = Backward helicopter
Rh = Right helicopter
Lh = Left helicopter
AL.R. = AileronL Right
AL.L. = AileronL Left
EL.D. = ElevatorL Down
EL.U. = ElevatorL Up
CL = CollectiveL
For definitions of CollectiveL, AileronL and ElevatorL, see explanation of FIG. 7.

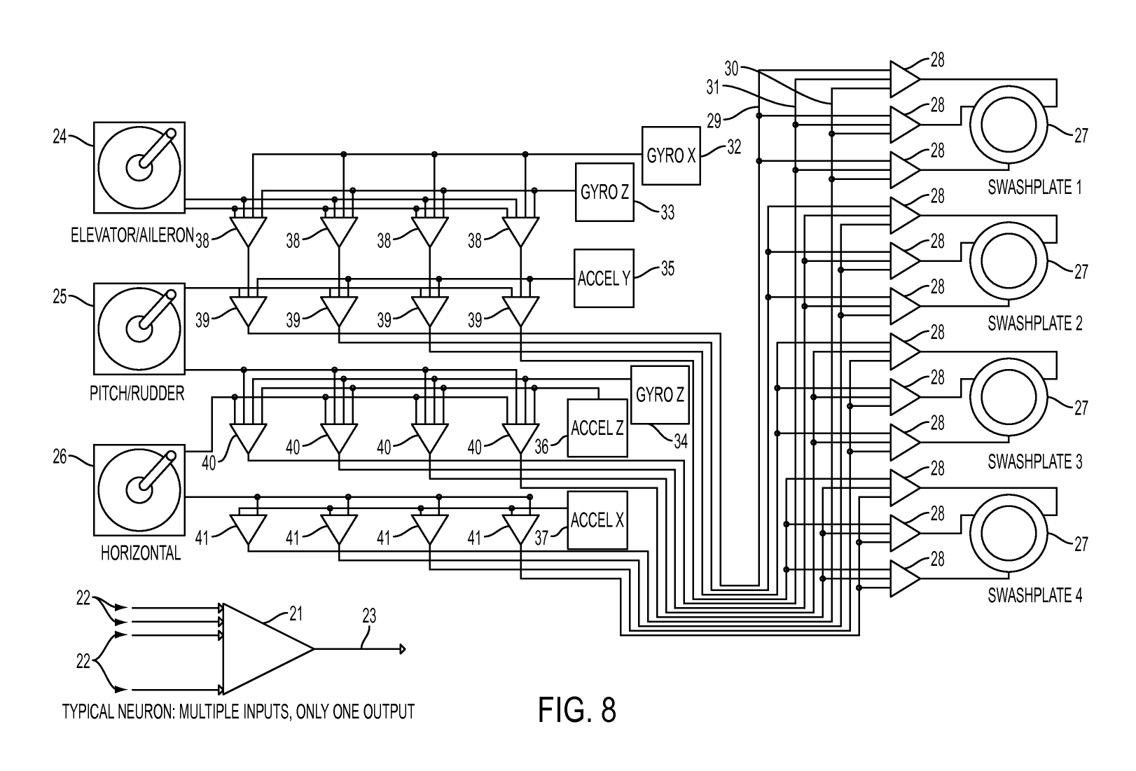

By summing up these control inputs from Scheme 2 with the control inputs CollectiveO, AileronO and ElevatorO (see explanation of FIG. 8), an aircraft may be controlled in a similar fashion as conventional helicopters, with the addition of the new control inputs.

The two or more swash plates are controlled by electric, hydraulic or mechanical means, with control inputs that may be generated manually or automatically, either from within the aircraft by a pilot or remotely by an operator. In order for a swash plate to be fully controllable, it requires at least 3 actuators. In addition to the operator controls required in the present art—collective, rudder, elevator and aileron—the present invention needs a control for ‘horizontal’. In total, this invention therefore requires 6 manual control inputs: collective, aileron, elevator, rudder, Hx and Hz.

In FIG. 7 it is depicted how the manual controls for Hx and Hz can be combined with the joy stick subassembly 11 that is used in the present art for elevator and aileron control. Tilting the joy stick forward and backward gives elevator control as depicted by curved arrow i; tilting it sideways produces aileron control as shown by curved arrow j. The novel feature allowing for Hx and Hz inputs is, that the entire joy stick subassembly 11 is mounted on a sliding platform 12 that can be moved horizontally in all directions on a stationary base 13. Thus, sliding the joy stick subassembly without tilting it will produce only Hx (arrow o) and/or Hz (arrow k) control outputs; tilting it without sliding it will produce only elevator i and/or aileron j; tilting and sliding simultaneously will produce mixed outputs.

In the preferred embodiment, manual input may be assisted or may even be replaced by automated inputs from sensors, both gyroscopes and accelerometers. Since there are 3 axis of rotation and equally 3 of linear movement, a total of 3 gyroscopes and 3 accelerometers may be employed to obtain stabilization in all degrees of freedom.

The control inputs will have to be processed in order to translate them into the inputs required to steer the individual swash plates according to scheme 1. Although this may be achieved through purely mechanical means, this would not be practical and incident prone. Therefore, in the preferred embodiment, this processing may be done electronically. A control system based on a freely programmable computer is possible, but would require sizeable computing power in order to combine these 12 inputs into the minimum of 12 outputs needed for independently steering the four swash plates. Furthermore, it would require extensive programming, debugging and testing before being put into service. The control system in the preferred embodiment of the present invention therefore relies on distributed, parallel processing by a network of slow, low wattage processors, each dedicated to a specific and limited task, which mimics in a sense the workings of neural networks found in living organisms. Because of the inherent logic and the self correcting properties of this network, no elaborate programming is required, with a sharply diminished need for debugging and testing. But, like with natural occurring neural networks, the neurons will have to be trained in order to perform their roles.

FIG. 8. shows the scheme for this electronic network. The network consists of artificial neurons and galvanic connections between them. Each artificial neuron shares some basic characteristics with biological neurons 21. That is, they can have any number of inputs 22, but may only generate one output 23. Each output may subsequently be input into any number of neurons. Each neuron functions as an elaborate mixer, combining any number of inputs into one specific output. Neurons communicate with each other by out- and inputting amplitude information, for which either analog, digital or pulse coded electric signals may employed. As a matter of fact, nature uses pulse coding, and so does the working prototype produced based on the principles set out above.

The way it works is as follows. On the left hand side, the input controls for elevator and aileron 24, pitch and rudder 25 and horizontal X and Y 26 are shown. On the right hand side, the four swash plates 27 are shown that need to be controlled by means of at minimum three inputs each. With these three inputs, the swash plates can be given any orientation, only limited by mechanical constraints. These inputs are derived from the output of an array of 12 neurons 28, which are each fed with three inputs: pitchL 29, elevatorL 30 and aileronL 31. These pitchL, elevatorL and aileronL inputs are derived from a network of 16 neurons 38, 39, 40, 41 that combine the inputs of the manual controls 24, 25, 26 with 3 gyroscopes 32, 33, 34 and 3 accelerometers 35, 36, 37. It is good to note, because this may be a source of confusion, that the pitchL, elevatorL and aileronL inputs thus provided to the swash plates, have to be seen as localized and are specific to each swash plate, thus the L at the end. They are therefore different from the control inputs with somewhat similar names that affect the whole aircraft, which shall therefore henceforth be called pitchO, elevatorO and aileronO, with the O standing for ‘overall’.

The functioning of the network of 16 neurons 38, 39, 40, 41 translating the O controls plus horizontal X and Z into the L controls needed for the swash plates is as follows.

The orientation of the aircraft in the XZ-plane can be influenced by varying the thrust in the four rotor heads, like is known in the present art. Like in the present art, the manual controls for the orientation in this plane are elevatorO and aileronO 24. The first horizontal array of neurons 38 combine these manual inputs with corrections of two gyros, one for stabilization along the X-axis 32 and one for the Z-axis 33, into a relative pitchL level required from each of the swash plates in order to arrive at a desired orientation. Before these pitch levels are fed into the array of neurons connected to the swash plates, however, a further manual control 24 has to be mixed into it in order to arrive at the desired overall pitch. This is what determines whether the aircraft climbs, descends or hovers. This is achieved by an array of neurons 39, that also mixes in information from an accelerometer along the Y-axis 35. This allows the aircraft to be stabilized in this direction. The output of this array of neurons 39 is pitchL, which is fed into the array of neurons 28.

The next two rows of neurons 40, 41 translate the inputs from rudder 25 and horizontal X and Z 26 into the desired aileronL and elevatorL inputs for each of the neurons in array 28 in accordance with scheme 1. The row of neurons 40 mix in information from a gyroscope 34 on the Z-axis in order to stabilize rudder, and information from accelerometer 36 for stabilization along the Z-axis. Thus mixed in, this then becomes output aileronL. The row of neurons 41 combines control inputs 26 with information from accelerometer 37 in order to output elevatorL.

All neurons in this set-up have to be trained to react in the desired way by combining any number of inputs into one unique output. The training of the neurons in the functioning prototype has been done manually, based both on theory and observed behavior of the craft, taking into account the requirements as set out in scheme 1.

In this way, the aircraft is stabilized for rotation and acceleration on all three axis, while allowing for control inputs in order to achieve the desired movements and orientations of the craft.

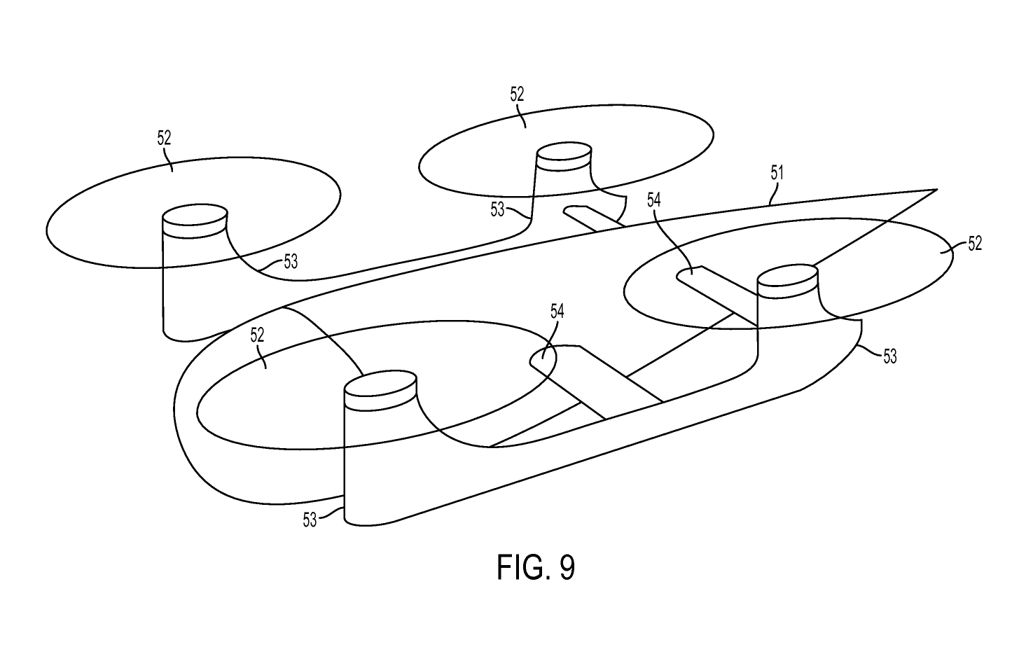

FIG. 9 shows the preferred embodiment for manned flight. A streamlined fuselage 51 is mounted between rotor heads 52 so that it remains out of the downwash of these rotors. Nacelles 53 enclose the drive train and actuators for the rotor heads in the most aerodynamic way, and are connected to the fuselage by wing shaped struts 54, which may be designed to produce additional lift in forward motion.

I claim:

1. A helicopter, comprising:
a helicopter fuselage;
at least two swash plates connected to said helicopter fuselage;
at least two rotor heads, where each of said at least two rotor heads is connected to a respective one of said at least two swash plates; and
a control system connected to each of said at least two swash plates and to each of said at least two rotor heads, where the control system permits full control of each respective swash plate for each of said at least two rotor heads.

2. The helicopter of claim 1, where the helicopter fuselage has a horizontal plane, and where the control system includes means for adjusting each of said at least two swash plates according to a novel control scheme such that propulsion force can be generated in the horizontal plane at each of said at least two rotor heads, to permit horizontal flight of said helicopter in all directions.

3. The helicopter of claim 1, where the helicopter fuselage has a horizontal plane and a vertical axis, and where the control system includes means for adjusting each of said at least two swash plates according to a novel control scheme such that propulsion force can be generated in the horizontal plane at each of said at least two rotor heads, to permit rudder control over all rotation about the vertical axis.

4. The helicopter of claim 1, where the fuselage includes a member mounted between said at least two rotor heads such that said member reduces the interaction of downwash from each of said at least two rotor heads and said fuselage.

5. The helicopter of claim 1, further comprising:
a manual input device connected to said control system, said input device including a sliding platform and a joystick, where a user may control steering the aircraft along the horizontal plane by moving the sliding platform so as to mimic the desired movements in the horizontal plane by the helicopter, and where the joy stick is connected to said sliding platform, said joystick connected to said control system for exercising elevator and aileron control of said at least two rotor heads.

6. The helicopter of claim 1, where said control system further comprises:
six manual inputs, where each of said six manual inputs represents one of six orthogonal directions;
at least one gyroscope for each rotational axis to be stabilized; and
at least one accelerometer for each longitudinal axis to be stabilized;
where the control system combines the six manual inputs with inputs from said at least one gyroscope and said at least one accelerometer, to generate the commands to steer the at least two swash plates such that propulsion force can be generated in the horizontal plane at each of said at least two rotor heads, to permit horizontal flight of said helicopter in all directions.

7. The helicopter of claim 6, where the control system includes a network of decentralized computers.

8. The helicopter of claim 7, where said network of decentralized computers includes at least one computer connected to each of said at least two swash plates.

9. A method for controlling a helicopter, comprising;
connecting at least two swash plates to a fuselage of said helicopter;
connecting a rotor head to each of said at least two swash plates;
connecting a control system to said at least two swash plates and to each said rotor head; and
sending control signals through said control system to said at least two swash plates and to each said rotor head to control each of said at least two swash plates.

10. The method of claim 9, where said control system includes a manual input device connected to said control system, said input device including a sliding platform and a joystick, where a user may control steering the aircraft along the horizontal plane by moving the sliding platform so as to mimic the desired movements in the horizontal plane by the helicopter, and where the joy stick is connected to said sliding platform, said joystick connected to said control system for exercising elevator and aileron control of said at least two rotor heads.

11. The method of claim 9, where said control system further includes:
six manual inputs, where each of said six manual inputs represents one of six orthogonal directions;
at least one gyroscope for each rotational axis to be stabilized; and
at least one accelerometer for each longitudinal axis to be stabilized; and
combining in the control system the six manual inputs with inputs from said gyroscopes and said accelerometers,;
generating in the control system commands to steer the at least two swash plates such that propulsion force can be generated in a horizontal plane at each of said at least two rotor heads, to permit horizontal flight of said helicopter in all directions.

12. The method of claim 11, where said control system includes a network of decentralized computers.

13. The method of claim 12, where said network of decentralized computers includes at least one computer connected to each of said at least two swash plates.
